(19) United States
(12) Patent Application Publication
(10) Pub. No.: US 2025/0075745 A1
(43) Pub. Date: Mar. 6, 2025

(54) POWER TRANSMISSION DEVICE FOR VEHICLE

(71) Applicant: TOYOTA JIDOSHA KABUSHIKI KAISHA, Toyota-shi (JP)

(72) Inventor: Masayuki ISHIBASHI, Numazu-shi (JP)

(73) Assignee: TOYOTA JIDOSHA KABUSHIKI KAISHA, Toyota-shi (JP)

(21) Appl. No.: 18/774,537

(22) Filed: Jul. 16, 2024

(30) Foreign Application Priority Data
Aug. 28, 2023 (JP) 2023-138455

(51) Int. Cl. F16D 3/06; F16D 3/14; F16H 57/021

(52) U.S. Cl. CPC F16D 3/06; F16D 3/14; F16H 57/021

(57) ABSTRACT

A vehicle power transmission device includes a shaft assembly constituted by an electric-motor rotor shaft and a gear shaft. The shaft assembly includes a connection portion in an end portion of the gear shaft is introduced in an end portion of the rotor shaft. The connection portion includes a spline engagement portion, a fitting portion and a damper portion in which an elastic member is disposed between an outer circumferential surface of the gear shaft and an inner circumferential surface of the rotor shaft. The spline engagement portion, the fitting portion and the damper portion are arranged in this order as viewed in a direction away from another end portion of the rotor shaft toward another end portion of the gear shaft. A bearing supporting the shaft assembly is located in a position that overlaps with the connection portion as viewed in a radial direction of the shaft assembly.

This application claims priority from Japanese Patent Application No. 2023-138455 filed on Aug. 28, 2023, the disclosure of which is herein incorporated by reference in its entirety.

### FIELD OF THE INVENTION

The present invention relates to a power transmission device for a vehicle, wherein the power transmission device includes a shaft assembly constituted by an electric-motor rotor shaft and a gear shaft that are connected to each other and coaxial with each other.

### BACKGROUND OF THE INVENTION

A power transmission device for a vehicle is known in which the power transmission device includes a shaft assembly constituted by an electric-motor rotor shaft and a gear shaft that are coaxial with each other, wherein the shaft assembly includes a connection portion in which one of axially opposite end portions of the gear shaft is introduced in one of axially opposite end portions of the rotor shaft such that the gear shaft and the electric-motor rotor shaft are connected to each other, wherein the connection portion includes: a spline engagement portion in which an outer circumferential surface of the gear shaft is engaged with an inner circumferential surface of the rotor shaft through a spline engagement; and a damper portion in which an elastic member is disposed between the outer circumferential surface of the gear shaft and the inner circumferential surface of the rotor shaft, such that the spline engagement portion and the damper portion are arranged in this order of description as viewed in a direction away from the other of the axially opposite end portions of the rotor shaft toward the other of the axially opposite end portions of the gear shaft. For example, Patent Document 1 discloses such a power transmission device. In the power transmission device disclosed in Patent Document 1, four bearings are provided to support the shaft assembly such that the shaft assembly is held by a non-rotating member through the bearings. Specifically, the four bearings are provided in respective four positions that correspond to the axially opposite end portions of the rotor shaft and the axially opposite end portions of the gear shaft.

### PRIOR ART DOCUMENT

### Patent Document

### [Patent Document 1]

Japanese Patent Application Laid-Open No. 2018-135934

### SUMMARY OF THE INVENTION

In the power transmission device disclosed in Patent Document 1, it is conceivable to reduce number of the bearings from four to three in order to reduce loss in the bearings. For example, in the power transmission device disclosed in Patent Document 1, it might be possible to eliminate one of the four bearings which is provided in the above-described one of the axially opposite end portions of the gear shaft on a side of the rotor shaft, and also to provide the connection portion of the shaft assembly with a fitting portion that is to be disposed between the damper portion and the above-described other of the axially opposite end portions of the gear shaft, in order to suppress misalignment of axes of the rotor shaft and the gear shaft. However, in the case where the spline engagement portion, the damper portion and the fitting portion are arranged in this order of description as viewed in the direction away from the other of the axially opposite end portions of the rotor shaft toward the other of the axially opposite end portions of the gear shaft, an outside diameter of the gear shaft in the fitting portion has to be increased, so as to be larger than an outside diameter of the gear shaft in the damper portion by an amount corresponding to the elastic member. The increase of the outside diameter of the gear shaft in the fitting portion requires an outside diameter of the rotor shaft in the fitting portion (in which the outside diameter of the rotor shaft is maximized) to be increased. This leads to increase in weight of the power transmission device.

The present invention has been made in view of the above circumstances, and an object of the present invention is to provide a power transmission device for a vehicle in which loss in bearings is reduced and increase in weight is suppressed.

The present invention provides a power transmission device for a vehicle. The power transmission device includes: (a) a shaft assembly constituted by an electric-motor rotor shaft and a gear shaft that are coaxial with each other; and (b) a bearing supporting the shaft assembly. The shaft assembly includes a connection portion in which one of axially opposite end portions of the gear shaft is introduced in one of axially opposite end portions of the rotor shaft such that the gear shaft and the electric-motor rotor shaft are connected to each other. The connection portion includes: a spline engagement portion in which an outer circumferential surface of the gear shaft is engaged with an inner circumferential surface of the rotor shaft through a spline engagement; a fitting portion in which the outer circumferential surface of the gear shaft is fitted in the inner circumferential surface of the rotor shaft; and a damper portion in which an elastic member is disposed between the outer circumferential surface of the gear shaft and the inner circumferential surface of the rotor shaft. The spline engagement portion, the fitting portion and the damper portion are arranged in an axial direction of the shaft assembly, such that the spline engagement portion is closer than the fitting portion and the damper portion to the other of the axially opposite end portions of the rotor shaft in the axial direction, and such that the damper portion is closer than the fitting portion and the spline engagement portion to the other of the axially opposite end portions of the gear shaft. The bearing supporting the shaft assembly is located in a position that overlaps with the connection portion of the shaft assembly as viewed in a radial direction of the shaft assembly. For example, the position of the bearing overlaps with the damper portion as viewed in the radial direction. Further, for example, the power transmission device includes a pair of end bearings in addition to the bearing as a central bearing that supports the connection portion of the shaft assembly, wherein one of the end bearings is provided in the other of the axially opposite end portions of the rotor shaft, and the other of the end bearings is provided in the other of the axially opposite end portions of the gear shaft.

In the power transmission device according to the present invention, the connection portion includes: the spline engagement portion in which the outer circumferential surface of the gear shaft is engaged with the inner circumferential surface of the rotor shaft through a spline engagement; the fitting portion in which the outer circumferential surface of the gear shaft is fitted in the inner circumferential surface of the rotor shaft; and the damper portion in which the elastic member is disposed between the outer circumferential surface of the gear shaft and the inner circumferential surface of the rotor shaft, wherein the spline engagement portion, the fitting portion and the damper portion are arranged in the axial direction of the shaft assembly, such that the spline engagement portion is closer than the fitting portion and the damper portion to the other of the axially opposite end portions of the rotor shaft in the axial direction, and such that the damper portion is closer than the fitting portion and the spline engagement portion to the other of the axially opposite end portions of the gear shaft, and wherein the bearing supporting the shaft assembly is located in the position that overlaps with the connection portion of the shaft assembly as viewed in the radial direction of the shaft assembly. In this way, where the spline engagement portion, the fitting portion and the damper portion are arranged in this order of description as viewed in a direction away from the other of the axially opposite end portions of the rotor shaft toward the other of the axially opposite end portions of the gear shaft, an outside diameter of the rotor shaft in the damper portion (in which the outside diameter of the rotor shaft is maximized) can be reduced as compared with an arrangement in which the spline engagement portion, the fitting portion and the damper portion are not arranged in this order. Thus, it is possible to reduce loss in the bearing, and to suppress increase in weight of the power transmission device.

### BRIEF DESCRIPTION OF THE DRAWINGS

FIG. 1 is a view schematically showing a construction of a vehicle equipped with a power transmission device according to an embodiment of the present invention.

FIG. 2 is a cross sectional view for explaining a construction of the power transmission device shown in FIG. 1.

### DETAILED DESCRIPTION OF PREFERRED EMBODIMENT

Hereinafter, an embodiment of the present invention will be described in detail with reference to drawings. The drawings are simplified or modified as appropriate, and dimensional ratios, shapes and the like of parts are not necessarily accurately drawn.

### Embodiment

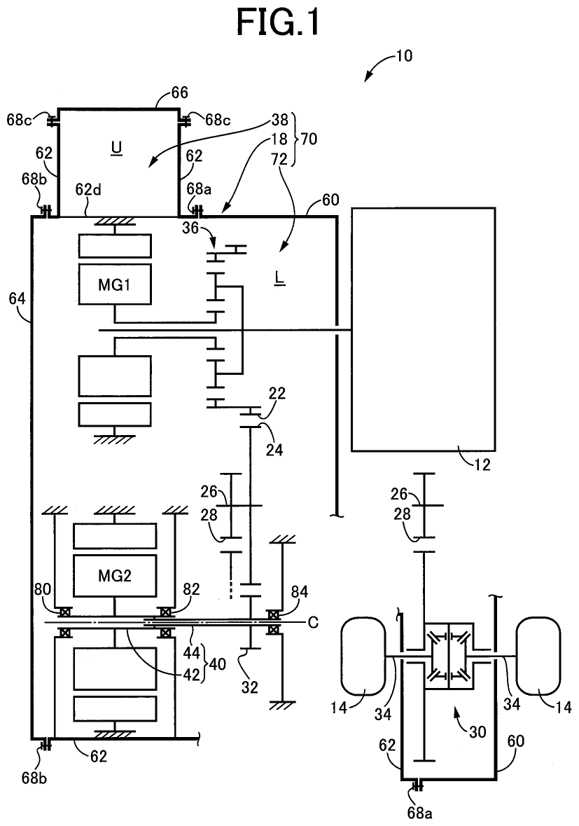

FIG. 1 is a view schematically showing a construction of a vehicle 10 equipped with a power transmission device 40 according to an embodiment of the present invention.

A first electric motor MG1 and a second electric motor MG2 are power sources for driving the vehicle 10, and are, for example, three-phase synchronous. motors which are so-called motor generators. The first electric motor MG1 and the second electric motor MG2 are housed accommodated in a casing 18 which is a non-rotating member attached to a body of the vehicle 10.

A transaxle 72 is housed in the casing 18. For example, a power outputted from an engine 12 is mechanically divided to the first electric motor MG1 and a drive gear 22 by a power dividing mechanism 36. The first electric motor MG1 generates an electric power by the power of the engine 12 divided to the first electric motor MG1. A generated electric power Wmg1 in the first electric motor MG1 is used to charge a battery (not shown). Further, the electric power of the battery as well as all or a part of the generated electric power Wmg1 is used for rotationally driving the second electric motor MG2. The power dividing mechanism 36 functions as an electrically continuously variable transmission. An operation state of the power dividing mechanism 36 is controlled with an operation state of the first electric motor MG1 being controlled. The power of the engine 12 divided by the drive gear 22 is transmitted to a driven gear 24, a driven shaft 26, a final gear 28 and a differential gear device 30. The second electric motor MG2 is connected to the driven shaft 26 via the power transmission device 40, the reduction gear 32 and the driven gear 24 in a power transmittable manner. The power transmission device 40 includes a shaft assembly, a first bearing 80, a second bearing 82 and a third bearing 84 that support the shaft assembly. The shaft assembly is constituted by a rotor shaft 42 of the second electric motor MG2 and a gear shaft 44 connected to the rotor shaft 42. The rotor shaft 42 and the gear shaft 44 are disposed on a common axis C so as to be coaxial with each other. An output of the transaxle 72 is transmitted to a pair of drive wheels 14 via a pair of axles 34 and the like connected to the differential gear device 30.

A power control unit 38 (hereinafter referred to as “PCU 38”) is an electric power control device configured to control the electric power transmitted and received between the battery (not shown) and the first and second electric motors MG1, MG2. The PCU 38 includes inverters configured to convert a direct current supplied from the battery, into an alternating current for driving the first and second electric motors MG1, MG2, and to convert the alternating current generated by the first and second electric motors MG1, MG2, into the direct current. The PCU 38 is controlled by an electronic control device (not shown) in accordance with a running state of the vehicle 10, whereby the output of each of the first and second electric motors MG1, MG2 is controlled.

The drive unit 70 is a mechanical-electrical integrated drive unit, i.e., a unit constituted by the transaxle 72 and the PCU 38 that are integrally housed in the same casing 18.

The meaning of “the same casing” will be described below. The casing 18 is made of, for example, a casting of an aluminum alloy, and includes a first casing member 60, a second casing member 62, a third casing member 64 and a fourth casing member 66.

The first casing member 60 is a bottomed cylindrical member. The second casing member 62 is a bottomed cylindrical member, and a partition wall 62d is provided inside the second casing member 62. For example, the second casing member 62 is formed by integrally casting a bottom, a side wall extending upward from outer peripheral edge of the bottom wall, and the partition wall 62d. The second casing member 62 has an opening on its upper surface. The second casing member 62 has an opening on a side of the engine 12 and another opening on a side opposite to the engine 12 in a lower portion of the sidewall of the second casing member 62 which is on a lower side of the partition wall 62d. The first casing member 60 and the second casing member 62 are integrally connected by fasteners such as bolts 68a (see FIG. 1) such that an opening of the first casing member 60 and the above-descried opening of the second casing member 62 are aligned with each other. The second casing member 62 is connected to the first casing member 60, and thus the casing 18 has an upper space U and a lower space L which are separated from each other by the partition wall 62d in a vertical direction. Here, a portion of the casing 18 surrounding the upper space U is referred to as an upper casing portion 18U, and a portion of the casing 18 surrounding the lower space L is referred to as a lower casing portion 18L. In the vertical direction, the lower casing portion 18L is a portion of the casing 18, which is located below the upper casing portion 18U. The partition 62d defines a lower end of the upper casing portion 18U and an upper end of the lower casing portion side 18L. Therefore, when the upper casing portion 18U and the lower casing portion 18L are separated from each other, an inside of at least one of the upper casing portion 18U and the lower casing portion 18L is necessarily exposed to an exterior of the casing 18. The “same casing” means a casing in which, when the upper casing portion 18U and the lower casing portion 18L are separated from each other, the inside of at least one of the upper casing portion 18U and the lower casing portion 18L is exposed to the exterior of the casing 18.

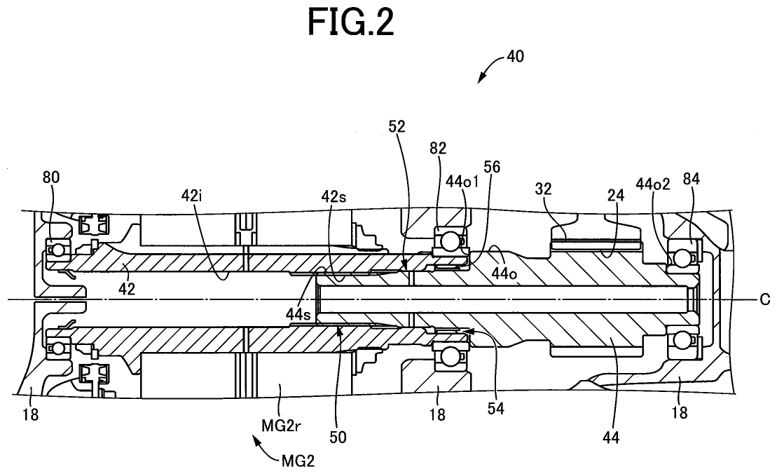

The third casing member 64 is a plate-like member connected to the second casing member 62 so as to close the above-described another opening of the second casing member 62. The second casing member 62 and the third casing member 64 are integrally connected by fasteners such as bolts 68b (see FIG. 1). The fourth casing member 66 is a plate-like member connected to the second casing member 62 so as to close the above-described opening in the upper surface of the second casing member 62. The second casing member 62 and the fourth casing member 66 are integrally connected to each other by fasteners such as bolts 68c (see FIG. 2). When being installed in the vehicle 10, the transaxle 72 is housed in the

lower casing portion 18L. That is, the transaxle 72 is provided in the lower space L. When being installed in the vehicle 10, the PCU 38 is housed in the upper casing portion 18U. That is, the PCU 38 is provided in the upper space U.

FIG. 2 is a cross sectional view for explaining a construction of the power transmission device 40 shown in FIG. 1, wherein the cross sectional view is a view of a cross section that includes the above-described common axis C.

The second electric motor MG2 is an inner-rotor type electric motor. The second electric motor MG2 corresponds to an “electric motor” in the present invention. The rotor shaft 42 is a cylindrical tubular member. An outer circumferential surface of the rotor shaft 42 is fixed to an inner circumferential surface of a rotor MG2r of the second electric motor MG2, such that the rotor shaft 42 and the rotor MG2r are not rotatable relative to each other.

The gear shaft 44 is a cylindrical tubular member. The reduction gear 32 is provided on an outer circumferential surface 44o of the gear shaft 44. The reduction gear 32 is engaged with the driven gear 24. The reduction gear 32 and the driven gear 24 are, for example, helical gears, and have a high meshing ratio to achieve quiet power transmission with a small torque variation. In a case where the reduction gear 32 and the driven gear 24 are the helical gears, a thrust force is generated in the gear shaft 44. The thrust force is a force acting in a direction of the axis C (=thrust direction). The thrust force acts in a first direction when the vehicle 10 run in a forward direction, and acts in a second direction when the vehicle 10 runs in a reverse direction, wherein the first and second directions are opposite to each other.

The shaft assembly includes a connection portion in which one of axially opposite end portions of the gear shaft 44 is introduced in one of axially opposite end portions of the rotor shaft 42 such that the gear shaft 44 and the rotor shaft 42 are connected to each other. The connection portion includes a spline engagement portion 50, a fitting portion 52 and a damper portion 54 that are arranged in this order of description as viewed in a direction away from the other of the axially opposite end portions of the rotor shaft 42 toward the other of the axially opposite end portions of the gear shaft 44. That is, the spline engagement portion 50, the fitting portion 52 and the damper portion 54 are arranged in an axial direction of the shaft assembly, i.e. in the direction of the axis C, such that the spline engagement portion 50 is closer than the fitting portion 52 and the damper portion 54 to the other of the axially opposite end portions of the rotor shaft 42 in the axial direction, and such that the damper portion 54 is closer than the fitting portion 52 and the spline engagement portion 50 to the other of the axially opposite end portions of the gear shaft 44.

In the spline engagement portion 50, the outer circumferential surface 44o of the gear shaft 44 is engaged with an inner circumferential surface 42i of the rotor shaft 42 through a spline engagement, namely, spline teeth 44s provided on the outer circumferential surface 44o of the gear shaft 44 are engaged with spline teeth 42s provided on the inner circumferential surface 42i of the rotor shaft 42. Between the spline teeth 42s and the spline teeth 44s, there is a play (backlash) in a circumferential direction of the shaft assembly. Due to a relative rotational fluctuation between the rotor shaft 42 and the gear shaft 44, the spline teeth 42s and the spline teeth 44s repeat a tooth-surface separation and a tooth-surface collision in the circumferential direction, and thus rattling noise (tooth-hitting noise) could be generated. For example, the relative rotational fluctuation occurs, when a torque outputted from the second electric motor MG2 is fluctuated, or when the torque outputted from the second electric motor MG2 is substantially zero and the rotor shaft 42 is dragged and rotated by the gear shaft 44 in a no-load state. The spline engagement portion 50 transmits a force acting in a rotational direction, i.e., circumferential direction of the shaft assembly between the rotor shaft 42 and the gear shaft 44.

In the fitting portion 52, the inner circumferential surface 42i of the rotor shaft 42 and the outer circumferential surface 44o of the gear shaft 44 are in contact with and fitted to each other. In a state where the rotor shaft 42 and the gear shaft 44 are connected to each other, the fitting portion 52 suppresses misalignment of the axes of the rotor shaft 42 and the gear shaft 44.

In the damper portion 54, a friction damper 56 is disposed between the inner circumferential surface 42i of the rotor shaft 42 and the outer circumferential surface 44o of the gear shaft 44. The damper 56 corresponds to an “elastic member” in the present invention. In the damper portion 54, an inside diameter of the rotor shaft 42 is larger than an outside diameter of the gear shaft 44. The damper 56 is disposed in an annular space between the inner circumferential surface 42i of the rotor shaft 42 and the outer circumferential surface 44o of the gear shaft 44 in the damper portion 54. The damper 56 is a well-known friction damper including, for example, an annular metal portion and an elastic body (for example, rubber) attached to an outer circumferential surface of the annular metal portion. The annular metal portion of the damper 56 is fitted on the outer circumferential surface 44o of the gear shaft 44, and the elastic body of the damper 56 is pressed between the metal portion and the inner circumferential surface 42i of the rotor shaft 42. The damper 56 suppresses occurrence of rattling noise in the rotation direction in the spline engagement portion 50 by applying a predetermined frictional resistance in the rotation direction, but provides little effect of suppressing the misalignment of the axes of the rotor shaft 42 and the gear shaft 44.

The power transmission device 40 is provided with the three bearings (the first bearing 80, the second bearing 82 and the third bearing 84) so as to be held by the casing 18 (specifically, the second casing member 62) that is a non-rotating member. These three bearings are bearings that can support both a load in a radial direction and a load in a thrust direction of the shaft assembly, and are, for example, ball bearings. In the direction of the axis C, the first bearing 80 and the third bearing 84 are provided in respective axially opposite end portions of the shaft assembly, namely, the first bearing 80 is provided in the above-described other of the axially opposite end portions of the rotor shaft 42 while the third bearings 84 is provided in the above-described other of the axially opposite end portions of the gear shaft 44. The second bearing 82 is provided in a position which is between the first and third bearings 80, 84 in the direction of the axis C and which overlaps with the above-described connection portion of the shaft assembly as viewed in a radial direction of the shaft assembly. In the present embodiment, the position of the second bearing 82 overlaps with the damper portion 54 as viewed in the radial direction. The second bearing 82 corresponds to a “bearing” or “central bearing” in the present invention. The first and third bearings 80, 84 correspond to a “pair of end bearings” in the present invention. Preferably, at least a part of the spline engagement portion 50 is provided in a position overlapping with the rotor MG2r as viewed in the radial direction. Further, a part of the damper portion 54 may be provided in a position overlapping with the rotor MG2r as viewed in the radial direction.

In the direction of the axis C, the first bearing 80 is provided in the above-described other of the axially opposite end portions of the rotor shaft 42 (i.e., in the axial end portion of the rotor shaft 42 which is remote from the gear shaft 44), while the second bearing 82 is provided in the above-described one of the axially opposite end portions of the rotor shaft 42 (i.e., in the axial end portion of the rotor shaft 42 which is close to the gear shaft 44). The rotor MG2r is located between the first and second bearings 80 and 82 in the direction of the axis C. In the direction of the axis C, the second bearing 82 is provided in the above-described one of the axially opposite end portions of the gear shaft 44 (i.e., in the axial end portion of the gear shaft 44 which is close to the rotor shaft 42), while the third bearing 84 is provided in the above-described other of the axially opposite end portions of the gear shaft 44 (i.e., in the axial end portion of the gear shaft 44 which is remote from the rotor shaft 42). The above-described one of the axially opposite end portions of the gear shaft 44 is held by the casing 18 through the friction damper 56, the rotor shaft 42 and the second bearing 82. The reduction gear 32 is located between the second and third bearings 82, 84 in the direction of the axis C. In order to support the thrust force of the gear shaft 44 by the casing 18 through the second and third bearings 82, 84, shoulder surfaces 44o1, 44o2 of the gear shaft 44 are in contact with axially end surfaces of inner races of the second and third bearings 82, 84, respectively.

Preferably, the above-described one of the axially opposite end portions of the rotor shaft 42 does not extend toward the gear shaft 44 beyond the second bearing 82 in the direction of the axis C. That is, a distal end of the above-described one of the axially opposite end portions of the rotor shaft 42 is spaced from the shoulder surface 44o1 by a small clearance in the direction of the axis C.

In the power transmission device 40 according to the present embodiment, the connection portion includes: the spline engagement portion 50 in which the outer circumferential surface 44o of the gear shaft 44 is engaged with the inner circumferential surface 42i of the rotor shaft 42 through a spline engagement; the fitting portion 52 in which the outer circumferential surface 44o of the gear shaft 44 is fitted in the inner circumferential surface 42i of the rotor shaft 42; and the damper portion 54 in which the elastic member is disposed between the outer circumferential surface 44o of the gear shaft 44 and the inner circumferential surface 42i of the rotor shaft 42, wherein the spline engagement portion 50, the fitting portion 52 and the damper portion 54 are arranged in the axial direction of the shaft assembly, such that the spline engagement portion 50 is closer than the fitting portion 52 and the damper portion 54 to the other of the axially opposite end portions of the rotor shaft 42 in the axial direction, and such that the damper portion 54 is closer than the fitting portion 52 and the spline engagement portion 50 to the other of the axially opposite end portions of the gear shaft 44, and wherein the second bearing 82 supporting the shaft assembly is located in the position that overlaps with the connection portion of the shaft assembly as viewed in the radial direction of the shaft assembly. In this way, where the spline engagement portion 50, the fitting portion 52 and the damper portion 54 are arranged in this order of description as viewed in a direction away from the other of the axially opposite end portions of the rotor shaft 42 toward the other of the axially opposite end portions of the gear shaft 44, the outside diameter of the rotor shaft 42 in the damper portion 54 does not have to be larger than the outside diameter of the rotor shaft 42 in the fitting portion 52, so that the outside diameter of the rotor shaft 42 in the damper portion 54 (in which the outside diameter of the rotor shaft 42 is maximized) does not have be made large, as compared with an arrangement in which the spline engagement portion 50, the damping portion 54 and the fitting portion 52 are arranged in this order of description as viewed in the direction away from the other of the axially opposite end portions of the rotor shaft 42 toward the other of the axially opposite end portions of the gear shaft 44. Thus, where the spline engagement portion 50, the fitting portion 52 and the damper portion 54 are arranged in this order of description as viewed in the direction away from the other of the axially opposite end portions of the rotor shaft 42 toward the other of the axially opposite end portions of the gear shaft 44, the diameter of the rotor shaft 42 in a portion in which the diameter of the rotor shaft 42 is maximized can be reduced as compared with the arrangement in which the spline engagement portion 50, the fitting portion 52 and the damper portion 54 are not arranged in this order. Thus, it is possible to reduce loss in the bearing, and to suppress increase in weight of the power transmission device 40. Further, since a part of the spline engagement portion 50 is provided in a position overlapping with the rotor MG2r in the direction of the axis C, it is possible to reduce a length of the shaft assembly (constituted by the rotor shaft 42 and the gear shaft 44) as a whole in the direction of the axis C. Accordingly, a total length of the drive unit 70, which is the mechanical-electrical integrated drive unit, for example, in the direction of the axis C can be reduced, and thus the drive unit 70 can be made in compact.

The present invention can be implemented in various forms with various modifications and improvements based on the knowledge of those skilled in the art without departing from the scope of the present invention.

In the above-described embodiment, the “elastic member” in the present invention is the friction damper 56, but the present invention is not limited thereto, and for example, a well-known tolerance ring may be used as the “elastic member”.

### NOMENCLATURE OF ELEMENTS

10: vehicle
40: power transmission device
42: rotor shaft
42i: inner circumferential surface
50: spline engagement portion
52: fitting portion
54: damper portion
44: gear shaft
44o: outer circumferential surface
56: friction damper (elastic member)
82: second bearing (bearing, central bearing)
C: axis
MG2: second electric motor (electric motor)

What is claimed is:

1. A power transmission device for a vehicle, the power transmission device comprising: (a) a shaft assembly constituted by an electric-motor rotor shaft and a gear shaft that are coaxial with each other; and (b) a bearing supporting the shaft assembly,
wherein the shaft assembly includes a connection portion in which one of axially opposite end portions of the gear shaft is introduced in one of axially opposite end portions of the rotor shaft such that the gear shaft and the electric-motor rotor shaft are connected to each other;
wherein the connection portion includes: a spline engagement portion in which an outer circumferential surface of the gear shaft is engaged with an inner circumferential surface of the rotor shaft through a spline engagement; a fitting portion in which the outer circumferential surface of the gear shaft is fitted in the inner circumferential surface of the rotor shaft; and a damper portion in which an elastic member is disposed between the outer circumferential surface of the gear shaft and the inner circumferential surface of the rotor shaft,
wherein the spline engagement portion, the fitting portion and the damper portion are arranged in an axial direction of the shaft assembly, such that the spline engagement portion is closer than the fitting portion and the damper portion to the other of the axially opposite end portions of the rotor shaft in the axial direction, and such that the damper portion is closer than the fitting portion and the spline engagement portion to the other of the axially opposite end portions of the gear shaft, and
wherein the bearing supporting the shaft assembly is located in a position that overlaps with the connection portion of the shaft assembly as viewed in a radial direction of the shaft assembly.

2. The power transmission device according to claim 1,
wherein the position of the bearing overlaps with the damper portion as viewed in the radial direction.

3. The power transmission device according to claim 1, comprising a pair of end bearings in addition to the bearing as a central bearing that supports the connection portion of the shaft assembly,
wherein one of the end bearings is provided in the other of the axially opposite end portions of the rotor shaft, and the other of the end bearings is provided in the other of the axially opposite end portions of the gear shaft.
